(19) United States
(12) Patent Application Publication
(10) Pub. No.: US 2025/0163306 A1
(43) Pub. Date: May 22, 2025

(54) METHOD FOR PRODUCING AUTOMOBILE STRUCTURAL BODY AND CURABLE COMPOSITION

(71) Applicants: CEMEDINE CO., LTD., Tokyo (JP); HONDA MOTOR CO., LTD, Tokyo (JP)

(72) Inventors: Yusuke MURACHI, Tokyo (JP); Yuuki TOUDE, Tokyo (JP); Minoru ITO, Tokyo (JP); Fumi SAKAE, Tokyo (JP); Atsuhiko SUZUKI, Tokyo (JP); Shoji KIMURA, Tokyo (JP); Chikanori WATANABE, Tokyo (JP); Mitsuru NAGAOKA, Tokyo (JP); Naoki TSURUTA, Tokyo (JP); Masayuki SUGIYAMA, Tokyo (JP)

(21) Appl. No.: 18/841,761

(22) PCT Filed: Mar. 1, 2023
(86) PCT No.: PCT/JP2023/007639

§ 371 Date: Aug. 27, 2024

(30) Foreign Application Priority Data
Mar. 28, 2022 (JP) 2022-052134

(51) Int. Cl. C09J 163/00; C09J 5/00; C09J 11/04; C09J 11/08

(52) U.S. Cl. CPC C09J 163/00; C09J 5/00; C09J 11/04; C09J 11/08

(57) ABSTRACT

Provided are a method of producing an automobile structure, which can suppress appearance failure of the automobile structure, and a curable composition that has enhanced thixotropy, an improved thread-forming property and excellent oily surface adhesion, and is suitably used in production of the automobile structure. The method of producing an automobile structure is a method of producing an automobile structure, including a step of applying a curable composition for production of an automobile structure to an adherend, the curable composition containing: (A) a liquid epoxy resin containing dispersed rubber particles; (B) a latent curing agent; (C) surface-treated fumed silica; (D) a block urethane resin; and (E) polyethylene powder, the curable composition having a ratio of a viscosity at a shear rate of 0.5/s to a viscosity at a shear rate of 1,000/s at 50° C. of 50 or more.

### TECHNICAL FIELD

The present invention relates to a method of producing an automobile structure, which can suppress appearance failure of the automobile structure, and a curable composition having enhanced thixotropy, an improved thread-forming property and excellent oily surface adhesion.

### BACKGROUND ART

Hitherto, structural adhesive compositions used to join body panels, body parts and the like of an automobile to produce automobile structures have been known. When a related-art structural adhesive composition containing a rubber component is applied as a structural adhesive composition in an automobile production assembly line, there has been a problem in that the adhesive adheres to an unintended area because of thread formation during stitch-pattern application, and the adhesion adversely affects electrodeposition application in the next step and deteriorates rust prevention and appearance. In particular, long thread formation causes the adhesive to protrude from a flange, resulting in appearance failure of an automobile structure.

In a shower step of the automobile production assembly line, the structural adhesive composition having a low viscosity under heating has low shower resistance and may be removed by a shower, and hence the related-art structural adhesive composition has been used in a location and a portion where the adhesive composition is unlikely to be removed by a shower.

As a structural adhesive composition having enhanced shower resistance and satisfactory thread breakage, in Patent Document 1, there is a proposal of a structural adhesive composition containing an epoxy resin in which rubber particles are dispersed in the state of primary particles and an epoxy resin latent curing agent. However, in recent years, further suppression of appearance failure, improvement in thread-forming property, enhancement in adhesion performance and the like have been desired.

### PRIOR ART DOCUMENTS

### Patent Documents

Patent Document 1: JP 6744405 B2
Patent Document 2: WO 2004/108825 A1

### SUMMARY OF THE INVENTION

### Problems to be Solved by the Invention

The present invention has been made in view of the above-mentioned problem of the related art, and an object of the present invention is to provide a method of producing an automobile structure, which can suppress appearance failure of the automobile structure, and a curable composition that has enhanced thixotropy, an improved thread-forming property and excellent oily surface adhesion, and is suitably used in production of the automobile structure.

### Means for Solving the Problems

In order to solve the above-mentioned problems, the inventors of the present invention have made extensive investigations, and as a result, have found that a thread-forming property has a correlation with thixotropy and that when a ratio of a viscosity at a shear rate of 0.5/s to a viscosity at a shear rate of 1,000/s at 50° C. (viscosity ratio “0.5/1,000”) is set to 50 or more, the thread-forming property can be significantly improved and appearance failure of an automobile structure due to an adhesive can be suppressed.

According to an embodiment of the present invention, there is provided a method of producing an automobile structure, including a step of applying a curable composition for production of an automobile structure to an adherend, the curable composition containing: (A) a liquid epoxy resin containing dispersed rubber particles; (B) a latent curing agent; (C) surface-treated fumed silica; (D) a block urethane resin; and (E) polyethylene powder, the curable composition having a ratio of a viscosity at a shear rate of 0.5/s to a viscosity at a shear rate of 1,000/s at 50° C. of 50 or more.

According to an embodiment of the present invention, there is provided a curable composition, including: (A) a liquid epoxy resin containing dispersed rubber particles; (B) a latent curing agent; (C) surface-treated fumed silica; (D) a block urethane resin; and (E) polyethylene powder, the curable composition having a ratio of a viscosity at a shear rate of 0.5/s to a viscosity at a shear rate of 1,000/s at 50° C. of 50 or more. This configuration can enhance thixotropy, improve a thread-forming property and significantly enhance oily surface adhesion.

The curable composition according to the embodiment of the present invention is suitable for a curable composition for production of an automobile structure.

### Advantageous Effect of the Invention

According to the present invention, the following remarkable effects are achieved. That is, there can be provided a method of producing an automobile structure, which can suppress, through use of a curable composition having enhanced thixotropy, an improved thread-forming property and excellent oily surface adhesion, appearance failure of the automobile structure due to thread formation of the curable composition, and which has excellent workability, and a curable composition that has enhanced thixotropy, an improved thread-forming property and excellent oily surface adhesion and is suitably used in production of the automobile structure.

### BRIEF DESCRIPTION OF THE DRAWINGS

FIG. 1(a) and FIG. 1(b) are each a photograph for showing a measurement technique in a thread-forming property test. FIG. 1(a) is a photograph for showing 30 stitches obtained by stitch-pattern application, and FIG. 1(b) is a partially enlarged photograph of FIG. 1(a) for showing a portion where a thread length is measured.

### MODE FOR CARRYING OUT THE INVENTION

Embodiments of the present invention are described below. However, the embodiments are described as examples, and needless to say, the present invention may be variously modified in a range not departing from the technical idea of the present invention.

A curable composition of the present invention includes: (A) a liquid epoxy resin containing dispersed rubber particles; (B) a latent curing agent; (C) surface-treated fumed silica; (D) a block urethane resin; and (E) polyethylene powder.

The curable composition has a ratio of a viscosity at a shear rate of 0.5/s to a viscosity at a shear rate of 1,000/s at 50° C. of 50 or more and has enhanced thixotropy, and has an improved thread-forming property, and further has excellent oily surface adhesion, and is suitable for, in particular, a structural adhesive composition used in production of an automobile structure.

A method of producing an automobile structure of the present invention is a method of producing an automobile structure, including a step of applying a curable composition for production of an automobile structure to an adherend, the curable composition containing: (A) a liquid epoxy resin containing dispersed rubber particles; (B) a latent curing agent; (C) surface-treated fumed silica; (D) a block urethane resin; and (E) polyethylene powder, the curable composition having a ratio of a viscosity at a shear rate of 0.5/s to a viscosity at a shear rate of 1,000/s at 50° C. of 50 or more.

The method of producing an automobile structure of the present invention is preferably a production method in an automobile production line, and the step of applying the curable composition to an adherend is suitably a step of applying the curable composition in a stitch pattern to the adherend under heating at from 40° C. to 60° C. The application under heating improves a discharge property from a nozzle, and hence the application under heating is preferred in the production line. Through the step of applying the curable composition to the adherend under heating at from 40° C. to 60° C. as described above, the adherend, such as a body panel, a hood, a door or a fender can be suitably bonded. In particular, in the present invention, a significant enhancement in thixotropy during heating improves a thread-forming property, and hence appearance failure of an automobile structure due to thread formation, which has occurred heretofore, can be suppressed.

The method of producing an automobile structure of the present invention is preferably a weld-bonding process (a process using an adhesive and spot welding in combination). In the present invention, the use of the curable composition that includes the components (A) to (E) and has enhanced thixotropy at 50° C. and excellent oily surface adhesion as an adhesive can improve a thread-forming property during stitch pattern application and can also enhance shower resistance. Accordingly, appearance failure of the automobile structure can be suppressed, and a portion where only spot welding has been possible heretofore can also be joined by the weld-bonding process. Thus, a portion where the adhesive is applied in an automobile body and the like can be increased, and rigidity can be enhanced, resulting in a reduction in weight of the automobile and an improvement in fuel efficiency.

Further, the curable composition has high shower resistance and satisfactory thread breakage. Thus, the curable composition is applicable to stitch-pattern application during use thereof in the automobile production line, and is excellent in workability. The stitch-pattern application refers to intermittently applying the adhesive. When the stitch-pattern application is applied in the weld-bonding process, the adhesive can be applied except for a portion that is subjected to spot welding, and a suppressing effect on the generation of smoke and combustion gas such as carbon dioxide by combustion of the adhesive and a reducing effect on the usage amount of the adhesive are obtained. In the method of producing an automobile structure of the present invention, the application is preferably performed with a robot coater.

### (Component A)

The liquid epoxy resin containing dispersed rubber particles serving as the component (A) has toughness-imparting and shower resistance-enhancing effects. The term “liquid” as used herein means a state in which a substance is fluid at room temperature (23° C.) and 1.01×10⁵ Pa. The liquid epoxy resin (A) is suitably an epoxy resin in which rubber particles are dispersed in the state of primary particles, more suitably a rubber particle-dispersed epoxy resin in which rubber particles having a number average particle diameter of from 10 nm to 1,000 nm are dispersed in the state of primary particles, and which has an epoxy equivalent of from 500 to 10,000. The rubber particles are preferably incorporated in an amount of from 1 part by mass to 100 parts by mass with respect to 100 parts by mass of the epoxy resin, and from the viewpoint of sufficiently obtaining the effects of the present invention, the rubber particles are more preferably incorporated in an amount of from 50 parts by mass to 90 parts by mass, and are still more preferably incorporated in an amount of from 60 parts by mass to 80 parts by mass.

The expression “the rubber particles are dispersed in the state of primary particles” as used herein means that cross-linked rubber particles preferably having a number average primary particle diameter of from 10 nm to 1,000 nm are each independently dispersed without being aggregated in the epoxy resin. A dispersion state of the rubber particles may be recognized by dissolving the rubber particle-dispersed epoxy resin in a solvent such as methyl ethyl ketone, and measuring the particle diameter with a particle diameter measurement device or the like through laser light scattering or the like or by observing the rubber particle-dispersed epoxy resin with an electron microscope.

In order to obtain the effects of the present invention by independently dispersing the rubber particles in the component (A) in the epoxy resin as described above, incompatibility with the epoxy resin is required. Accordingly, the rubber particles in the component (A) include: as a cross-linked rubber particle core layer, a core polymer that is preferably 55 mass % to 100 mass %, more preferably 60 mass % to 90 mass % of a polymer of a polymerization monomer for the cross-linked rubber particle core layer and is present on the inner side of the rubber particles, and as a hard polymer shell layer, a shell polymer that is preferably 0 mass % to 45 mass %, more preferably 10 mass % to 40 mass % of a polymer of a vinyl monomer as a polymerization monomer for the hard polymer shell layer and is present on the outer side of the rubber particles. The rubber particles are preferably those having a core-shell structure having the cross-linked rubber particle core layer and the hard polymer shell layer. The rubber particles are more preferably core-shell rubber particles in which the hard polymer shell layer is grafted on the cross-linked rubber particle core layer.

From the viewpoint of effectively improving toughness, the number average particle diameter of the rubber particles is from 10 nm to 1,000 nm, preferably from 10 nm to 600 nm, more preferably from 10 nm to 500 nm, still more preferably from 10 nm to 400 nm. The number average particle diameter of such rubber particles may be determined, for example, by a dynamic light scattering method or an electron microscope method.

The rubber particles in the component (A) are preferably cross-linked rubber particles. The cross-linked rubber particles are in a cross-linked state, and hence the rubber particles include a solvent-insoluble portion. The amount of a solvent-insoluble substance (that is, gel fraction with respect to the cross-linked rubber) in the rubber particles is expressed in mass percentage as the ratio of the mass of a residual sample with respect to the mass of a loaded sample, which is obtained by immersing a sample in an excess amount of methyl ethyl ketone (MEK) at room temperature for 24 hours, then removing a soluble portion and the solvent by centrifugation at 12,000 rpm for 1 hour, and measuring the mass of the residual MEK-insoluble substance. From the viewpoint of achieving excellent performance balance, the amount of the solvent-insoluble portion in the cross-linked rubber particles is preferably from 80 mass % to 100 mass %, particularly preferably from 90 mass % to 100 mass %.

The rubber particles used in the present invention are preferably particles each having a core-shell structure including the cross-linked rubber particle core layer and the hard polymer shell layer. From the viewpoint of improving toughness, the rubber particles are more preferably a graft copolymer including the hard polymer shell layer obtained by polymerizing one or more kinds of vinyl monomers in the presence of the cross-linked rubber particle core layer of one or more kinds selected from the group consisting of: a butadiene rubber; a butadiene-styrene rubber; a butadiene-butyl acrylate rubber; a butyl acrylate rubber; and an organosiloxane rubber, and more preferably a butadiene rubber. From the viewpoint of control of a particle size, the rubber particles are preferably particles produced by emulsion polymerization.

In the cross-linked rubber particle core layer, a component including the following vinyl monomer may be copolymerized at a ratio of less than 50% as long as the physical properties of the cross-linked rubber particle core layer are not impaired.

Examples of the vinyl monomer include: an aromatic vinyl monomer, such as styrene, α-methylstyrene, p-methylstyrene or divinylbenzene; a vinyl cyanide monomer, such as acrylonitrile or methacrylonitrile; methacrylic acid or a methacrylate, such as methyl methacrylate, ethyl methacrylate, butyl methacrylate, glycidyl methacrylate, hydroxyethyl methacrylate, ethylene glycol dimethacrylate or 1,3-butylene glycol dimethacrylate; and acrylic acid or an acrylate, such as methyl acrylate, butyl acrylate, glycidyl acrylate, hydroxybutyl acrylate or phenoxyethyl acrylate. The vinyl monomers may be used alone or as a mixtures thereof.

From the viewpoint of stably maintaining the rubber particles in the composition of the present invention for a long period of time, it is preferred that the rubber particles in the component (A) include an epoxy group and one or more kinds of groups selected from the group consisting of functional groups that can each react with the epoxy group, and it is more preferred that the hard polymer shell layer include the above-mentioned groups.

From the viewpoint of improving toughness, the glass transition temperature of the cross-linked rubber particle core layer is preferably 0° C. or less.

As the epoxy resin used in the component (A), an epoxy resin having an epoxy equivalent of from 80 to 10,000 may be used, and an epoxy resin having an epoxy equivalent of from 80 to 200 is preferred.

Examples of the epoxy resin include a glycidyl ether-substituted product of a compound having a known basic skeleton, such as a bisphenol compound, a hydrogenated bisphenol compound, a phenol or o-cresol novolac, an aromatic amine, a polycyclic aliphatic or aromatic compound, and a compound having a cyclohexene oxide skeleton. Typical examples thereof include diglycidyl ether of bisphenol A and a condensate thereof, that is, a so-called bisphenol A type epoxy resin.

In addition, as the epoxy resin in which the rubber particles in the component (A) are dispersed in the state of primary particles, for example, an epoxy resin composition described in Patent Document 2 may be used.

### (Component B)

As the latent curing agent serving as the component (B), a publicly known epoxy resin latent curing agent may be applied. For example, an epoxy resin latent curing agent that is activated by heating may be selected from the group consisting of: guanamines; guanidines; aminoguanidines; ureas; imidazoles; modified polyamines; and derivatives thereof, dicyandiamide; boron trifluoride-amine complexes; organic acid hydrazides; and melamine, and used. Of those, dicyandiamide, which is widely used, is preferred. The addition amount of the latent curing agent serving as the component (B) is determined according to the epoxy equivalent of a matrix.

### (Component C)

The surface-treated fumed silica serving as the component (C) has thixotropy-imparting and shower resistance-enhancing effects. As the surface-treated fumed silica serving as the component (C), fumed silica surface-treated with a publicly known surface treatment agent may be used. For example, surface-treated hydrophobic fumed silica that is surface-treated with a hydrophobizing agent, such as polydimethylsiloxane or dimethyl dichlorosilane, is suitably used. The specific surface area of the fumed silica serving as the component (C) is preferably from 10 m²/g to 500 m²/g, more preferably from 50 m²/g to 300 m²/g.

The blending ratio of the surface-treated fumed silica as the component (C) is not particularly limited, but is preferably from 5 parts by mass to 30 parts by mass with respect to 100 parts by mass of the epoxy resin serving as the component (A).

### (Component D)

The block urethane resin serving as the component (D) has toughness-imparting and adhesion-enhancing effects. As the block urethane resin serving as the component (D), a publicly known block urethane resin that is obtained by causing a polyhydroxy compound and a polyisocyanate compound to react with each other and then blocking the obtained urethane prepolymer with a blocking agent may be used. As the block urethane resin serving as the component (D), specifically, a block urethane that is obtained by causing a polyhydroxy compound and an excess amount of a polyisocyanate compound to react with each other and then blocking the obtained polyurethane having an isocyanate (NCO) content of from 0.1 mass % to 10 mass % with a blocking agent, such as an active methylene compound, an oxime compound, a phenol compound, a lactam compound or a secondary amine compound, is suitably used.

The blending ratio of the block urethane resin serving as the component (D) is not particularly limited, but is preferably from 25 parts by mass to 55 parts by mass with respect to 100 parts by mass of the epoxy resin serving as the component (A).

### (Component E)

The polyethylene powder serving as the component (E) has an adhesion-enhancing effect. In particular, the use of the polyethylene powder as the component (E) in combination with the block urethane resin as the component (D) can significantly enhance oily surface adhesion.

As the polyethylene powder serving as the component (E), a publicly known polyethylene resin powder may be used. The particle diameter of the polyethylene powder serving as the component (E) is not particularly limited. Polyethylene fine powder having a moderate particle size, which is measured by a laser method, of 100 μm or less is preferred, and a polyethylene fine powder having a moderate particle size of 50 μm or less is more preferred.

The blending ratio of the polyethylene powder serving as the component (E) is not particularly limited, but is preferably from 10 parts by mass to 45 parts by mass with respect to 100 parts by mass of the epoxy resin serving as the component (A).

### (Optional Component)

In addition to the above-mentioned components, an epoxy resin, a modified epoxy resin, a urethane resin, a curing accelerator, a filler, a diluent, a reactive diluent, a viscosity adjusting agent, a moisture absorbent, a silane coupling agent (for example, epoxysilane) or the like may be added to the curable composition as long as the effects of the present invention are not impaired. In addition to the above-mentioned components, an extender (filling material), such as calcium carbonate, barium sulfate, talc or wollastonite, or a colored pigment, such as an organic pigment (for example, monoazo pigment) or an inorganic pigment (for example, carbon black, titanium oxide or iron oxide), may be added. Further, a thixotropic agent, such as Ketjen black, silica, calcium carbonate fine particles or sepiolite, may be added. Further, an acrylic resin may be added as an adhesion improver of improving adhesion, such as peel strength.

It is suitable that the curable composition substantially contain no liquid rubber component.

When the curable composition has a ratio of the viscosity at a shear rate of 0.5/s to the viscosity at a shear rate of 1,000/s (viscosity ratio “0.5/1,000”) at 50° C. of 50 or more, the thread-forming property is improved, and the appearance failure of the automobile structure is suppressed. A viscosity ratio (0.5/1,000) of 65 or more is suitable because the appearance failure is suppressed.

The viscosity at a shear rate of 0.5/s at 50° C. is preferably from 700 (Pa·s) to 5,000 (Pa·s), more preferably from 1,000 (Pa·s) to 3,000 (Pa·s), and the viscosity at a shear rate of 1,000/s at 50° C. is preferably from 1 (Pa·s) to 30 (Pa·s).

The curable composition may be particularly suitably used in a one-pack type.

The curable composition may be used in various types of use applications, such as an adhesive, a coating material, a coating agent, a sealing material, a sticky material, a potting material, a putty material and a primer. The curable composition has enhanced thixotropy, an improved thread-forming property and excellent oily surface adhesion, and hence the curable composition is particularly preferably used in an adhesive for an automobile or the like. In addition, the curable composition may be used for various buildings, civil engineering, electrical and electronic fields and the like. When the curable composition is used as an adhesive for an automobile, the curable composition is suitably used to produce an automobile structure by structural bonding of parts, such as an automobile body or an automobile component, and other parts, and in particular, the curable composition is suitably used in bonding through a process (weld-bonding process) in which spot welding and an adhesive are used in combination. That is, the curable composition is suitably used to bond the automobile body.

### EXAMPLES

The present invention is more specifically described below by way of Examples. It goes without saying that Examples are given for illustrative purposes and should not be interpreted as limiting the present invention.

### Examples 1 to 3 and Comparative Examples 1 to 6

A curable composition was produced by the following procedure through use of components in amounts expressed in parts by mass shown in Table 1 below. Materials shown in Table 1 were blended in a 5 L universal mixing stirrer (manufactured by Dalton Corporation), stirred for 30 minutes, and then defoamed under reduced pressure for 10 minutes to prepare the curable composition.

TABLE 1

| | Example | Example | Example | Comparative | Comparative | Comparative | Comparative | Comparative | Comparative |
|---|---|---|---|---|---|---|---|---|---|
| | 1 | 2 | 3 | Example 1 | Example 2 | Example 3 | Example 4 | Example 5 | Example 6 |
| (A) Rubber | 100.0 | 100.0 | 100.0 | 100.0 | 100.0 | 100.0 | 100.0 | 100.0 | 100.0 |
| particle-dispersed | | | | | | | | | |
| epoxy resin *1 | | | | | | | | | |
| Bisphenol A type | 56.0 | 142.9 | 142.9 | 23.5 | 142.9 | 114.3 | 85.7 | 56.0 | 142.9 |
| epoxy resin *2 | | | | | | | | | |
| CTBN-modified | | | | | | 50.0 | 100.0 | | |
| epoxy resin *3 | | | | | | | | | |
| (B) Latent curing | 12.0 | 21.4 | 21.4 | 8.8 | 21.4 | 21.4 | 21.4 | 12.0 | 21.4 |
| agent *4 | | | | | | | | | |
| Curing accelerator | 2.0 | 3.6 | 3.6 | 1.5 | 3.6 | 3.6 | 3.6 | 2.0 | 3.6 |
| *5 | | | | | | | | | |
| (D) Block urethane | 28.0 | 50.0 | 50.0 | 11.8 | 28.6 | 28.6 | 28.6 | 16.0 | 28.6 |
| resin *6 | | | | | | | | | |
| (C) Surface-treated | 10.0 | 25.0 | 25.0 | | | | | 10.0 | 25.0 |
| fumed silica *7 | | | | | | | | | |
| Untreated silica *8 | | | | 7.4 | 17.9 | 17.9 | 17.9 | | |
| Calcium carbonate | 68.0 | 121.4 | 121.4 | 50.0 | 121.4 | 121.4 | 121.4 | 68.0 | 121.4 |
| *9 | | | | | | | | | |
| Surface-treated | 20.0 | 35.7 | 35.7 | 14.7 | 35.7 | 35.7 | 35.7 | 20.0 | 35.7 |
| calcium carbonate | | | | | | | | | |
| *10 | | | | | | | | | |
| Calcium oxide *11 | 8.0 | 14.3 | 14.3 | 5.9 | 14.3 | 14.3 | 14.3 | 8.0 | 14.3 |
| (E) Polyethylene | 12.0 | 21.4 | 42.9 | | | | | | |
| powder *12 | | | | | | | | | |
| Total | 316.0 | 535.7 | 557.1 | 223.5 | 485.7 | 507.1 | 528.6 | 292.0 | 492.9 |

The materials shown in Table 1 are as described below.
*1) Liquid epoxy resin in which a core-shell rubber is dispersed (blending amount of rubber particles: 40 mass %), “KANE ACE MX-154” manufactured by Kaneka Corporation
*2) Bisphenol A type epoxy resin “Epiclon 850” manufactured by DIC Corporation
*3) CTBN-modified epoxy resin “RA-840” manufactured by Huntsman Corporation
*4) Dicyandiamide “DYHARD 100SH” manufactured by AlzChem Group AG
*5) DCMU “DYHARD UR200” manufactured by AlzChem Group AG
*6) Block urethane resin “ADEKA RESIN QR-9466” manufactured by ADEKA Corporation
*7) Surface-treated fumed silica “TS-720” manufactured by Cabot Corporation
*8) Untreated silica “Aerosil R972” manufactured by Nippon Aerosil Co., Ltd.
*9) Calcium carbonate “Whiton SB” manufactured by Shiraishi Calcium Kaisha, Ltd.
*10) Surface-treated calcium carbonate “HAKUENKA CCR-B” manufactured by Shiraishi Kogyo Kaisha, Ltd.
*11) Calcium oxide “QC-X” manufactured by Inoue Calcium Corporation
*12) Polyethylene powder “FLO-THENE UF-20S” manufactured by Sumitomo Seika Chemicals Company, Limited.

The curable compositions produced in Examples 1 to 3 and Comparative Examples 1 to 4 as described above were subjected to the following performance tests, and the results are shown in Table 2 below.

### (1) Viscosity

The viscosity at 50° C. of each of the obtained curable compositions at shear rates of 5/s and 1,000/s was determined with RST-CPS equipped with a heater and sensor systems, manufactured by Brookfield. A curable composition having a viscosity ratio of the viscosity at a shear rate of 0.5/s to the viscosity at a shear rate of 1,000/s of 50 or more was evaluated as satisfactory (marked with the symbol “◯”), and a curable composition having a viscosity ratio of less than 50 was evaluated as unsatisfactory (marked with the symbol “x”).

### (2) Thread-Forming Property

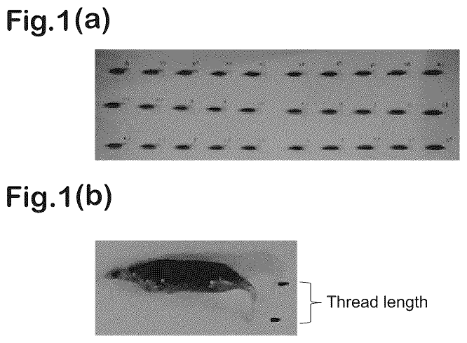

Each of the obtained curable compositions was subjected to stitch-pattern application with a robot coater under the following conditions, and its thread-forming property was measured. FIG. 1 show photographs for showing a measurement technique in a thread-forming property test.

SYS6000 manufactured by Atlas Copco AB was used as the robot coater.

The stitch-pattern application was performed on a 90° vertical surface at an application rate of 500 mm/s and an application temperature of 50° C. through use of a nozzle arranged at a distance of 6 mm from an application target. In the stitch-pattern application, 10 stitches were repeated 3 times as shown in FIG. 1(a). A hanging portion at the endpoint of each applied stitch was evaluated as a thread length as shown in FIG. 1(b). An average value of thread lengths of 30 stitches of 9 mm or less was evaluated as satisfactory (marked with the symbol “◯”), and an average value of more than 9 mm was evaluated as unsatisfactory (marked with the symbol “x”).

### (3) Oily Surface Adhesion Test

An oily surface adhesion test was performed by a peel strength evaluation described below through use of each of the obtained curable compositions as an adhesive.

Two cold-rolled steel plates each having a length of 200 mm, a width of 25 mm and a thickness of 0.6 mm were prepared, and were then each processed to be folded by 90° at a position distant from an edge thereof by 50 mm. The cold-rolled steel plates were coated with a processing oil of interest (anti-corrosion oil or press oil) and then vertically stood, and the processing oil was dried at 40° C. for 1 week. The cold-rolled steel plates were coated with an adhesive at a coating thickness of 0.2 mm. The two cold-rolled steel plates were superimposed so that the length of superimposed areas was 150 mm, and the protruding adhesive was removed. Thus, a peel test piece was produced. The peel test piece was put into a dryer at 160° C. and then heated so that the adhesive portion was held at 160° C. for 20 minutes. After baking, the peel test piece was allowed to cool for 24 hours and then subjected to a test with a universal tensile tester at a tensile rate of 200 mm/min. A peel test piece having a failure mode that was 100% cohesive failure (CF) was evaluated as satisfactory (marked with the symbol “◯”), and a peel test piece having a failure mode that was not 100% CF was evaluated as unsatisfactory (marked with the symbol “x”).

TABLE 2

| | Example | Example | Example | Comparative | Comparative | Comparative | Comparative | Comparative | Comparative |
|---|---|---|---|---|---|---|---|---|---|
| | 1 | 2 | 3 | Example 1 | Example 2 | Example 3 | Example 4 | Example 5 | Example 6 |
| Viscosity at 50° C. | 1,500 | 2,300 | 2,800 | 600 | 200 | 360 | 500 | 1,000 | 2,000 |
| 0.5/s (Pa · s) | | | | | | | | | |
| 1,000/s (Pa · s) | 15 | 10 | 20 | 15 | 8 | 12 | 15 | 5 | 5 |
| Viscosity ratio | 100 | 230 | 140 | 40 | 25 | 30 | 33 | 200 | 400 |
| “0.5/1,000” | ∘ | ∘ | ∘ | x | x | x | x | ∘ | ∘ |
| Thread-forming | ∘ | ∘ | ∘ | x | x | x | x | ∘ | ∘ |
| property (mm) | | | | | | | | | |
| Oily surface | ∘ | ∘ | ∘ | x | x | x | x | x | x |
| adhesion | | | | | | | | | |
| Anti-corrosion | | | | | | | | | |
| Oil (N/25 mm) | | | | | | | | | |
| Press oil | ∘ | ∘ | ∘ | x | ∘ | ∘ | ∘ | x | x |
| (N/25 mm) | | | | | | | | | |
| Oily surface | ∘ | ∘ | ∘ | x | x | x | x | x | x |
| adhesion | | | | | | | | | |
| Overall | | | | | | | | | |
| evaluation | | | | | | | | | |

In each of Examples 1 to 3, excellent oily surface adhesion was exhibited, the viscosity ratio was 50 or more and the thixotropy was enhanced, and the thread length was 9 mm or less on average and the thread-forming property was improved. Meanwhile, in each of Comparative Examples 1 to 6, the results of at least one or all of the thixotropy, the thread-forming property and the oily surface adhesion were poor.

1. A curable composition, comprising:
(A) a liquid epoxy resin containing dispersed rubber particles;
(B) a latent curing agent;
(C) surface-treated fumed silica;
(D) a block urethane resin; and
(E) polyethylene powder,
the curable composition having a ratio of a viscosity at a shear rate of 0.5/s to a viscosity at a shear rate of 1,000/s at 50° C. of 50 or more.

2. The curable composition according to claim 1, wherein the curable composition is a curable composition for production of an automobile structure.

3. A method of producing an automobile structure, comprising a step of applying a curable composition for production of an automobile structure to an adherend,
the curable composition containing:
(A) a liquid epoxy resin containing dispersed rubber particles;
(B) a latent curing agent;
(C) surface-treated fumed silica;
(D) a block urethane resin; and
(E) polyethylene powder,
the curable composition having a ratio of a viscosity at a shear rate of 0.5/s to a viscosity at a shear rate of 1,000/s at 50° C. of 50 or more.
